(19) United States
(12) Patent Application Publication
(10) Pub. No.: US 2007/0014296 A1
(43) Pub. Date: Jan. 18, 2007

(54) Clock recovery method and apparatus for constant bit rate (CBR) traffic

(75) Inventors: Hyun-surk Ryu, Suwon-si (KR); Geoffrey M. Garner, Red Bank, NJ (US); Fei Fei Feng, Yongin-si (KR); Cornelis Johannis Den Hollander, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/487,461

(22) Filed: Jul. 17, 2006

Related U.S. Application Data
(60) Provisional application No. 60/699,381, filed on Jul. 15, 2005.

(30) Foreign Application Priority Data
Apr. 12, 2006 (KR) 2006-0033202
Jul. 10, 2006 (KR) 2006-64580

(51) Int. Cl. H04L 12/56; H04L 12/28

(52) U.S. Cl. 370/395.4; 370/395.62

(57) ABSTRACT

Disclosed is a clock recovery method and apparatus for CBR traffic in the packet switching network so as to recover the clock of the CBR traffic upon transmission by inserting a small amount of random packets to the CBR traffic stream which has arrived in a receiver. According to the present inventive concept, the CBR streams are added with the random traffic streams in the packet switching network, so that the clock of the CBR streams upon transmission can be recovered, and jitter and wander according to clock recovery can be reduced.

### CROSS-REFERENCE TO RELATED APPLICATIONS

This application claims the benefit under 35 U.S.C. § 119(a) of Korean Patent Application Nos. 10-2006-0033202 filed on Apr. 12, 2006 and 10-2006-0064580 filed on Jul. 10, 2006 in the Korean Intellectual Property Office, and U.S. Provisional application No. 60/699,381 filed on Jul. 15, 2005 in the USPTO, the entire disclosure of which is incorporated herein by reference.

### BACKGROUND OF THE INVENTION

1. Field of the Invention

The present invention generally relates to a clock recovery method and apparatus for constant bit rate (CBR) traffic in a packet switching network. More particularly, the present invention relates to a clock recovery method and apparatus for CBR traffic in the packet switching network including an asynchronous transfer mode (ATM) so as to recover the clock of the CBR traffic upon transmission by adding a small amount of random packets to the CBR traffic stream which has arrived in a receiver.

2. Description of the Related Art

Generally, in a packet switching network, a data stream passes the network at a certain rate.

FIG. 1 shows a conventional CBR stream scheduling method.

As shown in FIG. 1, a plurality of CBR streams 10 through 14 are input to one node, and a scheduler 20 enqueues the plurality of the input CBR streams to a queue in sequence according to the input order and sends them to an output link

Although the nominal rates of the CBR packet streams are the same, the actual rates are slightly different, which leads to a beating of the streams against each other when the CBR packet streams are actually transmitted to the same physical layer. Jitter and wander result from phase steps occurring when a fast stream passes a slow stream ahead. The jitter and the wander can have very low frequency contents due to little difference between the rates, which can be hard to filter.

In the transmission, with respect to the jitter and the wander due to packet delay variability (PDV), the bandwidth of the filter should be smaller than a frequency content of the PDV by comparing them. In addition, the amplitude of the PDV for the CBR stream can be reduced by giving the CBR stream which has priority over the VBR traffic stream.

However, as for the multiple CBR streams, all of them typically compete for the same bandwidth and have the equal priority. While giving one CBR stream priority would reduce the jitter and wander amplitude for that stream, it would make the jitter and wander of competing CBR streams worse. Therefore, when a reception side receives the CBR stream, its clock is different from the clock of the transmission side.

### SUMMARY OF THE INVENTION

The present invention has been provided to address the above-mentioned and other problems and disadvantages occurring in the conventional arrangement, and an aspect of the present invention is to provide a clock recovery method and apparatus for CBR traffic in the packet switching network so as to recover the clock of the CBR traffic upon transmission by adding a small amount of random packets to the CBR traffic stream which has arrived in a receiver.

According to an aspect of the present invention, there is provided a clock recovery method for constant bit rate (CBR) streams, comprising receiving a plurality of CBR streams, performing scheduling by adding random traffic streams to the CBR streams, and outputting the scheduled CBR streams and random traffic streams.

The random traffic streams are generated at random by a scheduler which performs scheduling, and are added to the CBR streams.

The random traffic streams are generated by the scheduler and are temporarily stored in a memory.

In the performing the scheduling, each of the CBR streams stand by in a queue, and the random traffic streams are added among the CBR streams.

A clock recovery apparatus for a CBR traffic, comprising a stream storage which stores a plurality of CBR streams input from outside, and a scheduler which performs scheduling by adding random traffic streams to the plurality of CBR streams, and outputs the scheduled streams.

The scheduler generates the random traffic streams at random and adds the random traffic streams to the CBR streams.

The scheduler generates the random traffic streams and temporarily stores in the stream storage, if the CBR streams are input.

The scheduler performs the scheduling by placing the CBR streams in a queue and placing the random traffic streams among the CBR streams.

### BRIEF DESCRIPTION OF THE DRAWING FIGURES

These and/or other aspects of the present invention will become more apparent and more readily appreciated from the following description of exemplary embodiments thereof, with reference to the accompanying drawings, in which:

FIG. 1 is a diagram for illustrating a conventional CBR stream scheduling method;

FIG. 2 is a schematic diagram for illustrating the configuration of a modulator apparatus for CBR traffic according to an exemplary embodiment of the present invention and

FIG. 3 is a diagram for illustrating the operation of a clock recovery apparatus according to an exemplary embodiment of the present invention; and

FIG. 4 is a flow chart for illustrating a clock recovery method of CBR traffic according to an exemplary embodiment of the present invention.

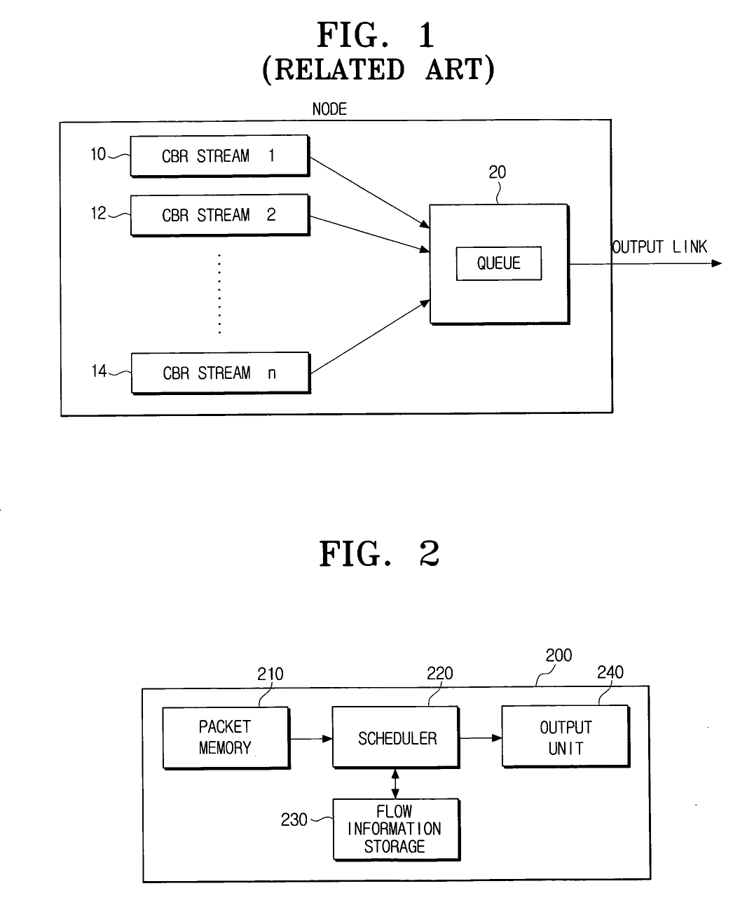

### DETAILED DESCRIPTION OF THE EXEMPLARY EMBODIMENTS

Certain exemplary embodiments of the present invention will now be described in greater detail with reference to the accompanying drawings.

In the following description, the same drawing reference numerals are used to refer to the same elements, even in different drawings. The matters defined in the following description, such as detailed construction and element descriptions, are provided as examples to assist in a comprehensive understanding of the invention. Also, well-known functions or constructions are not described in detail, since they would obscure the invention in unnecessary detail.

The method of the present invention is based on the fact that adding the random packet arrivals of the same priority in with the CBR streams tends to make the phase waveforms much less regular.

A small amount of random traffic of the same priority tends to shift the frequency contents of the phase variation waveform to a higher frequency.

The higher frequency phase variation is then much easier to filter. This method requires that a small amount of the bandwidth be reserved for the random traffic. It is not necessary that this random traffic be actual traffic. The importance of the random traffic is that it delays the CBR traffic packets. The precise nature of the random traffic is to be determined, e.g., its inter-arrival time distribution and correlation structure of the successive arrivals.

FIG. 2 is a schematic diagram for illustrating the configuration of a modulator apparatus for CBR traffic according to an exemplary embodiment of the present invention.

In the embodiment of the present invention, a modulator apparatus 200 includes a packet memory 210, a scheduler 220, a flow information storage 230 and an output unit 240.

The packet memory 210 stores data packets input from the outside. That is, the packet memory 210 is a stream storage which stores the plurality of CBR streams. In addition, the packet memory 210 temporarily stores random traffic streams generated by the scheduler 220.

The scheduler 220 performs scheduling by adding random traffic streams to the CBR streams input from the outside. To this end, the scheduler 220 generates random traffic streams at random.

The scheduler 220 places the CBR streams for output in a queue 225, and performs scheduling by placing random traffic streams among the CBR streams. In addition, the scheduler 220 can perform scheduling based on the flow information when scheduling each stream.

The flow information storage 230 stores data packet information according each flow, for example, flow ID, flag, quanta value, deficit value, initial packet pointer, next flow pointer, and so on.

The output unit 240 outputs the scheduled CBR streams and random traffic streams.

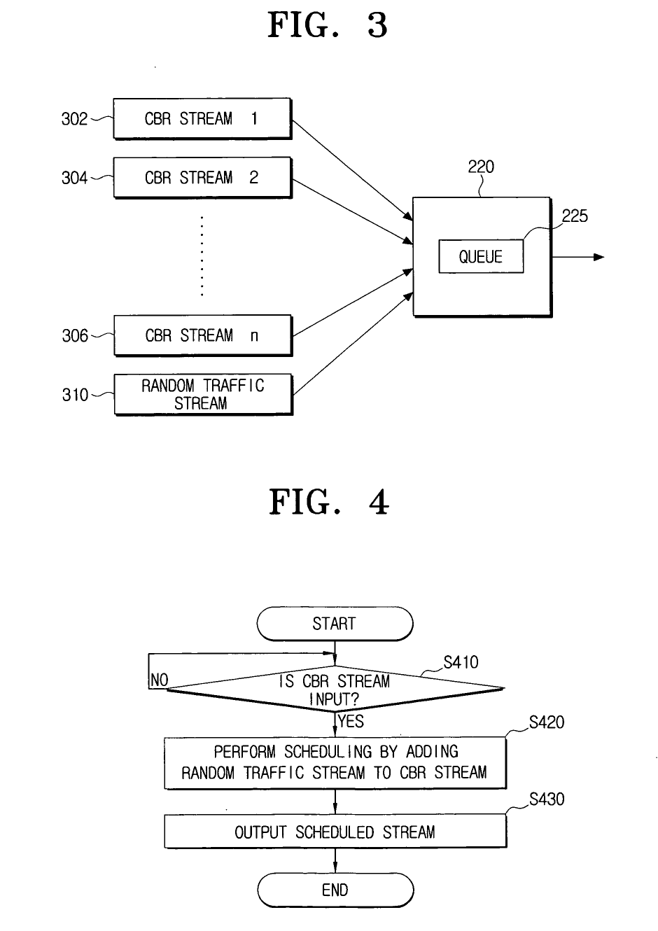

FIG. 3 is a diagram for illustrating the operation of a clock recovery apparatus according to an exemplary embodiment of the present invention, and FIG. 4 is a flow chart for illustrating a clock recovery method of CBR traffic according to an exemplary embodiment of the present invention.

Referring to FIG. 3, a plurality of CBR streams are received in the clock recovery apparatus 200 and are stored in the packet memory 210.

Subsequently, the CBR streams are activated by an output command from a user, and are input from the packet memory 210 to the scheduler 220 (S410).

The scheduler 220 places each of the CBR stream packets in the queue 225 based on the flow information of the flow information storage 230, generates random traffic streams at random, and adds the generated random traffic streams to the CBR streams to perform scheduling (S420).

The random traffic stream can be immediately generated by the scheduler 220 when the CBR streams are input to the scheduler 220.

Additionally, the random traffic streams can be previously generated by the scheduler 220 before the CBR streams are input to the scheduler 220, and be temporarily stored in the packet memory 210. In this case, the scheduler 220 performs scheduling by reading the random traffic streams from the packet memory 210 and adding the random traffic streams to the CBR streams.

Next, the clock recovery apparatus 200 outputs the scheduled CBR streams and random traffic streams by the output unit 240 (S430).

The small amount of random traffic streams with the same priority makes frequency contents of the phase variation waveform shifted to a higher frequency so that the original clock can be recovered.

Therefore, the clock recovery apparatus 200 can recover the clock of the CBR streams upon transmission by adding the random traffic streams.

As set forth above, the CBR streams are added with the random traffic streams in the packet switching network, so that the clock of the CBR streams upon transmission can be recovered, and jitter and wander according to clock recovery can be reduced.

While the present invention has been particularly shown and described with reference to exemplary embodiments thereof, it will be understood by those skilled in the art that various changes in form and details may be made therein without departing from the spirit and scope of the invention as defined by the appended clams.

What is claimed is:

1. A clock recovery method for constant bit rate (CBR) streams, comprising:
receiving a plurality of CBR streams;
performing scheduling by adding random traffic streams to the CBR streams; and
outputting the scheduled CBR streams and random traffic streams.

2. The clock recovery method of claim 1, wherein the random traffic streams are generated at random by a scheduler which performs scheduling, and are added to the CBR streams.

3. The clock recovery method of claim 2, wherein the random traffic stems are generated by the scheduler and are temporarily stored in a memory.

4. The clock recovery method of claim 1, wherein in the performing the scheduling, each of the CBR steams stand by in a queue, and the random traffic streams are placed among the CBR streams.

5. A modulator apparatus for a CBR traffic, comprising:
a stream storage which stores a plurality of CBR streams input from outside; and
a scheduler which performs scheduling by adding random traffic streams to the plurality of CBR streams, and outputs the scheduled streams.

6. The modulator apparatus of claim 5, wherein the scheduler generates the random traffic streams at random and adds the random traffic rams to the CBR streams.

7. The modulator apparatus of claim 5, wherein the scheduler generates the random traffic streams and temporarily stores in the stream storage, if the CBR streams are input.

8. The modulator apparatus of claim 5, wherein the scheduler performs the scheduling by standing by the CBR streams in a queue and placing the random traffic streams among the CBR streams.
